(19) United States
(12) Patent Application Publication
(10) Pub. No.: US 2008/0101286 A1
(43) Pub. Date: May 1, 2008

(54) METHODS AND APPARATUS FOR SCHEDULING UPLINK TRANSMISSIONS FOR REAL TIME SERVICES DURING A SILENT PERIOD

(75) Inventors: Jin Wang, Central Islip, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/925,342

(22) Filed: Oct. 26, 2007

Related U.S. Application Data
(60) Provisional application No. 60/863,348, filed on Oct. 28, 2006.

(51) Int. Cl. H04Q 7/00

(52) U.S. Cl. 370/329

(57) ABSTRACT

Method and apparatus for scheduling uplink transmissions for real time services during a silent period are disclosed. A schedule for a persistent radio resource for transmissions of non-silence insertion description (SID) frames during a silent period may be generated based on wireless transmit/receive unit (WTRU) mobility and other factors. Two separate schedules for SID frames and non-SID frames may be generated independently. The radio resource assigned for transmissions of the non-SID frames may be released when the WTRU has other uplink transmissions that are frequent enough to support transmissions of the non-SID frames and the non-SID frames may be transmitted via said other uplink transmissions. The WTRU may send a scheduling request when the WTRU needs to transition from the silent state to a talk spurt state via a synchronized random access channel (RACH) if a latency requirement cannot be satisfied with the radio resource allocated for the non-SID frames.

### CROSS REFERENCE TO RELATED APPLICATION

This application claims the benefit of U.S. provisional application No. 60/863,348 filed Oct. 28, 2006, which is incorporated by reference as if fully set forth.

### FIELD OF THE INVENTION

The present invention is related to wireless communications.

### BACKGROUND

Third generation partnership project (3GPP) is developing long term evolution (LTE) of universal mobile telecommunication services (UMTS) terrestrial radio access (UTRA) and UMTS terrestrial radio access network (UTRAN) for providing a high data rate, low latency, packet-optimized system with improved system capacity and coverage. In order to achieve these goals, an evolution of radio interface and radio network architecture is considered. For example, instead of using code division multiple access (CDMA) which is currently used in 3GPP, orthogonal frequency division multiple access (OFDMA) and single carrier frequency division multiple access (SC-FDMA) are adopted as air interface technologies to be used in the downlink and uplink transmissions, respectively.

One of the big changes in LTE is that all communications are made on a packet switched basis including voice calls. This leads to many challenges in LTE system design to support real time services, such as voice over Internet protocol (VoIP) services.

While VoIP users may get the same benefit of advanced link adaptation and statistical multiplexing techniques that are used in the LTE system as data users, the greatly increased number of users that may be served by the system because of the smaller voice packet sizes may place a significant burden on the control and feedback mechanisms of the LTE system. The conventional resource allocation and feedback mechanisms are typically not designed to deal with such a large peak-to-average number of allocations.

Allocating downlink and uplink radio resource of every transmission time interval (TTI) for the VoIP services will increase the layer 1 (L1) and layer 2 (L2) control signaling overhead in the uplink and downlink. Therefore, the resource allocation scheme that reduces the L1 and L2 control signaling overhead for uplink data transmission should be considered for VoIP services because the session period is longer than other bursty type traffics, such as Web-browsing.

Persistent resource scheduling has been proposed for real time services (such as VoIP services) for both the downlink and the uplink for efficient resources utilization. During persistent scheduling the radio resources are allocated over (defined or undefined) multiple TTIs without an L1 or L2 control channel for the optimization of voice traffic. Persistent scheduling may take advantage of the characteristics of predetermined packet size and packet arriving interval during the traffic session. With the persistent resource scheduling, the scheduling overhead on the control channel may be greatly reduced.

However, static persistent scheduling is not efficient for VoIP services because it does not consider the effect of voice activity factor (VAF) and hybrid automatic repeat request (HARQ) early termination. The VoIP traffic will, in general, use less than 50% of the allocated resources.

FIG. 1 shows conventional traffic model for VoIP services. In VoIP services, a talk spurt state and a silent state alternate. The packet inter-arrival time in a codec is constant (20 msec) in the talk spurt state. During the silent state, a wireless transmit/receive unit (WTRU) transmits a silence insertion description (SID) frame is transmitted every 160 msec. The packet size is almost constant in each state. The packet size is 35-49 byte in the talk spurt state, and 10-24 byte in the silent state when an adaptive multi-rate (AMR) rate is 12.2 kbps.

A Node-B assigns radio resources for the talk spurt state and the silent state for the WTRU in a persistent manner so that the radio resources are assigned for multiple TTIs. During the silent state, in addition to the radio resource for transmission of the SID frame, a dedicated uplink resource is also allocated for the WTRU for non-SID frame transmission. Conventionally, the dedicated uplink resource for non-SID frame transmissions has a fixed interval which is an integer fraction of 160 ms, (e.g., 80 ms, 40 ms), and the same amount of resource is allocated over the silent state.

The currently proposed LTE system has the following problems with respect to the VoIP services. First, during the voice silent period, when a WTRU has no other uplink traffic and no downlink traffic which may incur enough uplink data-associated or non-data-associated control channels, dedicated uplink channels need to be allocated for scheduling request and other data transmissions as well as uplink synchronization. However, the interval of uplink dedicated resources may not be fixed. It may vary based on many factors, such as mobility and reporting requirement. Second, the necessary uplink dedicated radio resources and interval during a talk spurt period may be different from the amount of resources and interval needed during the silent period. For example, the resources and interval needed for uplink channel quality indicator (CQI) reporting and SID frame may be different. Third, during the silent period, the WTRU may have frequent other uplink traffics and may have downlink traffic which requires frequent uplink feedback channels.

Therefore, it would be desirable to provide procedures and signaling methods to realize adaptive scheduling of uplink resources, to support different scheduling requirement during the silent period, to fully utilize the available other uplink channels and release the allocated dedicated uplink channels for the VoIP services, and to meet the latency requirement when a WTRU is transitioning from the silent state to the talk spurt state.

### SUMMARY

A method and apparatus for scheduling uplink transmissions for real time services during a silent period are disclosed. A schedule for a persistent radio resource for transmissions of non-SID frames during a silent period may be generated based on WTRU mobility and other factors. A first schedule for persistent radio resource for transmissions of SID frames and a second schedule for persistent radio resources for transmissions of non-SID frames may be generated independently. The radio resource assigned for transmission of the non-SID frames may be released when the WTRU has other uplink transmissions that are frequent enough to support the transmission of the non-SID frames and the non-SID frames may be transmitted via other uplink transmissions. The WTRU may send a scheduling request when the WTRU needs to transition from the silent state to a talk spurt state via a synchronized random access channel (RACH) if a latency requirement for transitioning from the silent state to the talk spurt state cannot be satisfied with the radio resource allocated for transmission of the non-SID frames during the silent period.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional traffic model for VoIP services; and

FIG. 2 is a block diagram of a system including a WTRU and a Node-B.

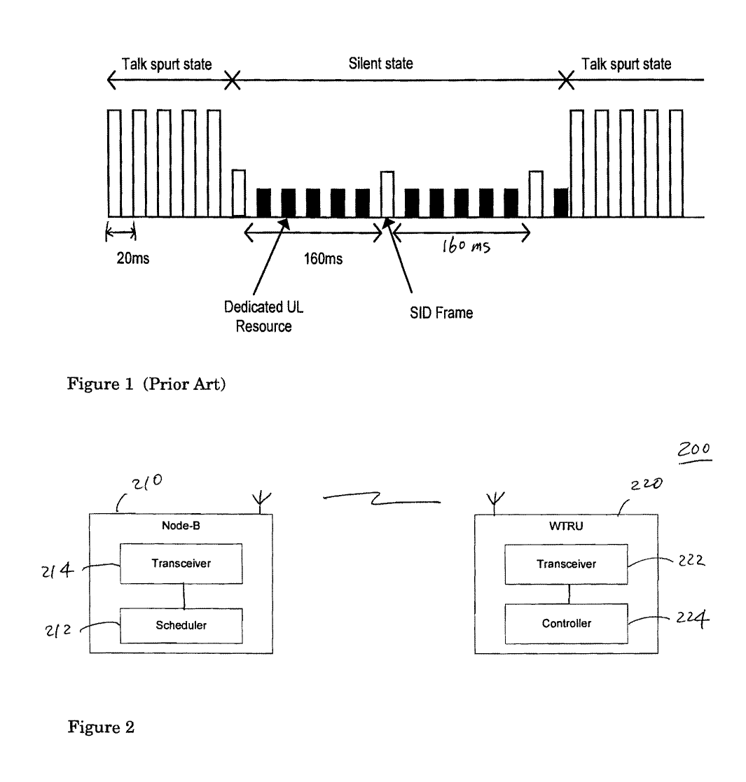

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

The present invention is applicable to any wireless communication system including, but not limited to, LTE and third generation (3G) high speed packet access (HSPA) system. In addition, VoIP services are illustrated as one specific example and the present invention is applicable to any intermittent transmitting applications.

FIG. 2 is a block diagram of a system 200. The system 200 includes a Node-B 210 and a WTRU 220. The Node-B 210 includes a scheduler 212 and a transceiver 214. The scheduler 212 generates a persistent schedule for the uplink resources for real time services, (such as VoIP services). The scheduler 212 generates two different uplink transmission intervals for the silent state: one schedule for SID frame transmissions and the other for non-SID frame transmissions. The non-SID frames are for maintaining uplink synchronization, uplink scheduling requests, and measurement reports (such as CQI), and the like. The scheduler 212 allocates, de-allocates and re-allocates radio resources to the WTRU 220 depending on the voice traffic activity. The schedule is sent to the WTRU 220 via the transceiver 214.

The WTRU 220 includes a transceiver 222 and a controller 224. The controller 224 receives the persistent scheduling and controls the transceiver 222 to transmit and receive packets during the talk spurt state and the silent state. The controller 224 also sends a scheduling request to the Node-B 210 when the WTRU 220 needs to transition from the silent state to the talk spurt state.

In accordance with a first embodiment, the radio resource for the non-SID packet transmission is scheduled by the Node-B scheduler 212 based on WTRU mobility. In addition to the WTRU mobility, the Node-B scheduler 212 may also consider other factors including, but not limited to, required measurement reporting interval, scheduling request to minimize the traffic latency, uplink synchronization maintenance, and the like. Conventionally, the radio resource for non-SID frame transmissions has a fixed interval which is an integer fraction of 160 ms, (e.g., 80 ms, 40 ms), and the same amount of resource is allocated over the silent state. In accordance with the first embodiment, the radio resource, (i.e., the interval, the amount of resource, etc.), for the non-SID frame transmission can be dynamically adjusted based on the WTRU mobility and other factors.

For example, the non-SID frame transmission interval may be determined to the minimum interval determined based on the WTRU mobility and other factors during the silent period. The allocated interval should not exceed a maximum interval. If the estimated WTRU mobility indicates a minimum interval among different required uplink intervals during the silent period, that interval is assigned to the WTRU for periodicity of the persistent scheduling during the silent period. If the WTRU is moving at high speed, the WTRU needs to transmit uplink transmissions at a shorter time interval, (e.g., to maintain the uplink synchronization). This interval may be shorter than the required channel quality indicator (CQI) reporting and scheduling request interval.

In accordance with a second embodiment, the interval for SID frame transmissions and the interval for non-SID frame transmission are scheduled independently based on transmission load requirements, quality of service (QoS), or the like. The uplink transmission interval for the non-SID frame does not have to be integer fraction of 160 ms, which is the transmission interval of the SID frames. For example, the transmission interval of the non-SID frame may be 30 ms. In this way, the radio resources can be utilized efficiently.

Control signaling for allocating radio resources for the non-SID frame transmissions and the SID frame transmissions during the silent period may be carried by one of the L1 signaling, L2 signaling, and radio resource control (RRC) signaling. An extension of previous radio resource allocation for the SID frame and non-SID frame transmissions may all be included in one control message. The transmission interval for non-SID frame transmissions may change during the silent period due to some condition changes such as WTRU mobility. An indicator or profile identity (ID) may be used to differentiate the configuration control message for different persistency allocations. The periodic uplink resources assigned for the silent period may be shared by multiple WTRUs in a multiplexing way.

The control information for persistent scheduling for non-SID frame transmission may include:
a. purpose of this set of resource allocation such as synchronization, scheduling request and CQI reporting, or the like;
b. time interval;
c. total duration of that persistent transmission;
d. physical radio resources allocations; and
e. frequency hopping pattern (optional).

The control information for persistent scheduling for SID frame transmission may include:
a. total duration of that transmissions (this one can be combined with the total duration for the non-SID frame);
b. physical radio resources allocations; and
c. frequency hopping pattern (optional). The frequency hopping pattern may be the same or different from the frequency hopping pattern for the non-SID frame.

In accordance with a third embodiment, the persistent uplink radio resource may be terminated early during the silent period. During the silent period, the WTRU may have other uplink traffics, (i.e., non-VoIP traffic), that are frequent enough, or downlink traffics which require uplink feedback, (data associated or non-data-associated), that is frequent enough to support the non-SID frame transmissions. The Node-B may utilize these available uplink channels for non-SID frame transmission purpose, such as scheduling request, CQI report, uplink synchronization maintenance, or the like, and may release the dedicated uplink radio resources allocated for non-SID frame transmissions. The message for terminating the persistent uplink radio resource allocation may be carried by one of L1 signaling, L2 signaling, and RRC signaling. Radio resource for the non-SID frame transmissions may be re-allocated if other uplink traffic or the uplink feedback is not frequent enough to support the non-SID frame transmissions during the silent period. This makes the radio resource utilization more efficient.

When the WTRU needs to transition from the silent state to the talk spurt state, the WTRU first sends a resource request to the Node-B. The Node-B then sends a resource allocation message to the WTRU. There is a latency requirement for the transition from the silent state to the talk spurt state, (e.g., 40 ms). When this latency requirement cannot be satisfied with the dedicated uplink resource allocated for the WTRU for the silent period, the WTRU may use a synchronized RACH or any other relevant channel for the resource request. If the latency requirement may be satisfied, the resource request (both initial and retransmission) may be sent via the uplink resource assigned for the non-SID frame transmission during the silent period.

For example, if voice call latency requirement is 40 ms, the uplink transmission interval is allocated as 30 ms, and the WTRU needs to transition to the talk spurt state 10 ms past last non-SID frame transmission, the WTRU may wait for another 20 ms for the next transmission interval since it is still within the latency requirement. If this initial request fails and if the WTRU has to wait for the next transmission interval for retransmission, it will be total 20+30=50 ms, which exceeds the latency requirement. Thus, after failure of the initial resource request, the WTRU may use a synchronized RACH or any other relevant channel to send the resource request again until the new uplink resource is allocated. To increase successful transmission of the resource request, the WTRU may use the maximum transmission power. Alternatively, the transmission power may be increased gradually with the increased number of retransmissions of the resource request.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for scheduling uplink transmissions for real time services during a silent period, the method comprising:
a Node-B generating a schedule for a persistent radio resource for transmissions of non-silence insertion description (SID) frames during a silent period based on wireless transmit/receive unit (WTRU) mobility;
the Node-B sending the schedule to a WTRU; and
the Node-B receiving non-SID frames from the WTRU during the silent period based on the schedule.

2. The method of claim 1 wherein the schedule is generated further based on at least one of measurement reporting interval, scheduling request, and uplink synchronization maintenance.

3. The method of claim 1 further comprising:
the Node-B releases the radio resource assigned for the non-SID frames when the WTRU has other uplink transmissions that are frequent enough to support the transmissions of the non-SID frames, wherein the non-SID frames are transmitted via said other uplink transmissions.

4. The method of claim 3 wherein said other uplink transmissions are uplink feedback transmissions in response to downlink transmissions.

5. The method of claim 3 further comprising:
the Node-B reassigning radio resource for transmissions of the non-SID frames when there is not enough of said other uplink transmissions to support transmissions of the non-SID frames.

6. A method for scheduling uplink transmissions for real time services during a silent period, the method comprising:
a Node-B generating a first schedule for persistent radio resource for transmissions of silence insertion description (SID) frames and a second schedule for persistent radio resources for transmissions of non-SID frames during a silent period independently;
the Node-B sending the first schedule and the second schedule to a wireless transmit/receive unit (WTRU); and
the Node-B receiving frames and non-SID frames during the silent period in accordance with the first schedule and the second schedule, respectively.

7. The method of claim 6 wherein the second schedule is changed during the silent period based on WTRU mobility.

8. The method of claim 6 wherein the schedule is sent to the WTRU via at least one of layer 1 (L1) signaling, layer 2 (L2) signaling, and radio resource control (RRC) signaling.

9. The method of claim 6 further comprising:
the Node-B releases the radio resource assigned for transmissions of the non-SID frames when the WTRU has other uplink transmissions that are frequent enough to support the transmissions of the non-SID frames, wherein the non-SID frames are transmitted via said other uplink transmissions.

10. The method of claim 9 wherein said other uplink transmissions are uplink feedback transmissions in response to downlink transmissions.

11. The method of claim 9 further comprising:
the Node-B reassigning radio resource for transmissions of the non-SID frames when there are not enough of said other uplink transmissions to support transmissions of the non-SID frames.

12. The method of claim 6 wherein the first schedule includes at least one of total duration, physical radio resources allocations and frequency hopping pattern.

13. The method of claim 6 wherein the second schedule includes at least one of purpose of resource allocation, time interval, total duration, physical radio resources allocations and frequency hopping pattern.

14. A method for uplink transmissions for real time services during a silent period, the method comprising:
a wireless transmit/receive unit (WTRU) receiving a schedule for a persistent radio resource for transmissions of non-silence insertion description (SID) frames during a silent period, the schedule being generated based on WTRU mobility; and
the WTRU sending non-SID frames during the silent period based on the schedule.

15. The method of claim 14 further comprising:
the WTRU transmitting the non-SID frames via other uplink transmissions that are frequent enough to support transmissions of the non-SID frames.

16. The method of claim 15 wherein said other uplink transmissions are uplink feedback transmissions in response to downlink transmissions.

17. The method of claim 14 further comprising:
the WTRU sending a scheduling request when the WTRU needs to transition from the silent state to a talk spurt state; and
the WTRU receiving a resource allocation in response to the scheduling request, wherein the WTRU sends the non-SID frames based on the resource allocation.

18. The method of claim 17 wherein the WTRU sends the scheduling request via a synchronized random access channel (RACH) if a latency requirement for transitioning from the silent state to the talk spurt state cannot be satisfied with the radio resource allocated for transmissions of the non-SID frames during the silent period.

19. The method of claim 18 wherein the WTRU uses a maximum transmission power from transmitting the scheduling request via the synchronous RACH.

20. A method for uplink transmissions for real time services during a silent period, the method comprising:
a wireless transmit/receive unit (WTRU) receiving a first schedule for persistent radio resource for transmissions of silence insertion description (SID) frames and a second schedule for persistent radio resources for transmissions of non-SID frames during a silent period, the first schedule and the second schedule being generated independently; and
the WTRU sending SID frames and non-SID frames during the silent period in accordance with the first schedule and the second schedule, respectively.

21. The method of claim 20 further comprising:
the WTRU transmitting the non-SID frames via other uplink transmissions that are frequent enough to support transmissions of the non-SID frames.

22. The method of claim 20 wherein said other uplink transmissions are uplink feedback transmissions in response to downlink transmissions.

23. The method of claim 20 further comprising:
the WTRU sending a scheduling request when the WTRU needs to transition from the silent state to a talk spurt state; and
the WTRU receiving a resource allocation in response to the scheduling request, wherein the WTRU sends the non-SID frames based on the resource allocation.

24. The method of claim 23 wherein the WTRU sends the scheduling request via a synchronized random access channel (RACH) if a latency requirement for transitioning from the silent state to the talk spurt state cannot be satisfied with the radio resource allocated for transmissions of the non-SID frames during the silent period.

25. The method of claim 24 wherein the WTRU uses a maximum transmission power from transmitting the scheduling request via the synchronous RACH.

26. A Node-B for scheduling uplink transmissions for real time services during a silent period, the Node-B comprising:
a scheduler configured to generate a schedule for a persistent radio resource for transmissions of non-silence insertion description (SID) frames during a silent period based on wireless transmit/receive unit (WTRU) mobility;
a transceiver configured to send the schedule to a WTRU; and
the transceiver further configured to receive non-SID frames during the silent period based on the schedule.

27. The Node-B of claim 26 wherein the scheduler generates the schedule further based on at least one of measurement reporting interval, scheduling request, and uplink synchronization maintenance.

28. The Node-B of claim 26 wherein the scheduler releases the radio resource assigned for the non-SID frames when the WTRU has other uplink transmissions that are frequent enough to support the transmissions of the non-SID frames, wherein the non-SID frames are transmitted via said other uplink transmissions.

29. The Node-B of claim 28 wherein said other uplink transmissions are uplink feedback transmissions in response to downlink transmissions.

30. The Node-B of claim 28 wherein the scheduler reassigns radio resource for transmissions of the non-SID frames when said other uplink transmissions become not enough to support transmissions of the non-SID frames.

31. A Node-B for scheduling uplink transmissions for real time services during a silent period, the Node-B comprising:
a scheduler for generating a first schedule for persistent radio resource for transmissions of silence insertion description (SID) frames and a second schedule for persistent radio resources for transmissions of non-SID frames during a silent period independently; and
a transceiver for sending the first schedule and the second schedule to a wireless transmit/receive unit (WTRU) so that the WTRU sends SID frames and non-SID frames during the silent period in accordance with the first schedule and the second schedule, respectively.

32. The Node-B of claim 31 wherein the scheduler changes the second schedule during the silent period based on WTRU mobility.

33. The Node-B of claim 31 wherein the schedule is sent to the WTRU via at least one of layer 1 (L1) signaling, layer 2 (L2) signaling, and radio resource control (RRC) signaling.

34. The Node-B of claim 31 wherein the scheduler releases the radio resource assigned for transmissions of the non-SID frames when the WTRU has other uplink transmissions that are frequent enough to support the transmissions of the non-SID frames, wherein the non-SID frames are transmitted via said other uplink transmissions.

35. The Node-B of claim 34 wherein said other uplink transmissions are uplink feedback transmissions in response to downlink transmissions.

36. The Node-B of claim 34 wherein the scheduler reassigns a radio resource for transmissions of the non-SID frames when said other uplink transmissions become not enough to support transmissions of the non-SID frames.

37. The Node-B of claim 31 wherein the first schedule includes at least one of total duration, physical radio resources allocations and frequency hopping pattern.

38. The Node-B of claim 31 wherein the second schedule includes at least one of purpose of resource allocation, time interval, total duration, physical radio resources allocations and frequency hopping pattern.

39. A wireless transmit/receive unit (WTRU) for uplink transmissions for real time services during a silent period, the WTRU comprising:
a transceiver for receiving a schedule for a persistent radio resource for transmissions of non-silence insertion description (SID) frames during a silent period, the schedule being generated based on WTRU mobility; and
a controller for sending non-SID frames during the silent period based on the schedule.

40. The WTRU of claim 39 wherein the controller transmits the non-SID frames via other uplink transmissions that are frequent enough to support transmissions of the non-SID frames.

41. The WTRU of claim 40 wherein said other uplink transmissions are uplink feedback transmissions in response to downlink transmissions.

42. The WTRU of claim 39 wherein the controller sends a scheduling request when the WTRU needs to transition from the silent state to a talk spurt state and sends the non-SID frames based on resource allocation received in response to the scheduling request.

43. The WTRU of claim 42 wherein the controller sends the scheduling request via a synchronized random access channel (RACH) if a latency requirement for transitioning from the silent state to the talk spurt state cannot be satisfied with the radio resource allocated for transmissions of the non-SID frames during the silent period.

44. The WTRU of claim 43 wherein the controller uses a maximum transmission power from transmitting the scheduling request via the synchronous RACH.

45. A WTRU for uplink transmissions for real time services during a silent period, the WTRU comprising:
a transceiver for receiving a first schedule for persistent radio resource for transmissions of silence insertion description (SID) frames and a second schedule for persistent radio resources for transmissions of non-SID frames during a silent period, the first schedule and the second schedule being generated independently; and
a controller for sending SID frames and non-SID frames during the silent period in accordance with the first schedule and the second schedule, respectively.

46. The WTRU of claim 45 wherein the controller sends the non-SID frames via other uplink transmissions that are frequent enough to support transmissions of the non-SID frames.

47. The WTRU of claim 45 wherein said other uplink transmissions are uplink feedback transmissions in response to downlink transmissions.

48. The WTRU of claim 45 wherein the controller sends a scheduling request when the WTRU needs to transition from the silent state to a talk spurt state and sends the non-SID frames based on resource allocation received in response to the scheduling request.

49. The WTRU of claim 48 wherein the controller sends the scheduling request via a synchronized random access channel (RACH) if a latency requirement for transitioning from the silent state to the talk spurt state cannot be satisfied with the radio resource allocated for transmissions of the non-SID frames during the silent period.

50. The WTRU of claim 49 wherein the controller uses a maximum transmission power from transmitting the scheduling request via the synchronous RACH.
